(19) United States
(12) Patent Application Publication
(10) Pub. No.: US 2003/0077125 A1
(43) Pub. Date: Apr. 24, 2003

(54) Methods of fitting linings in pipelines

(75) Inventor: Albert Ploeg, Apeldoorn (NL)

Correspondence Address: FULWIDER PATTON LEE & UTECHT, LLP, 200 OCEANGATE, SUITE 1550, LONG BEACH, CA, 90802, US

(73) Assignee: Heerema Marine Contractors Nederland B.V.

(21) Appl. No.: 10/273,544

(22) Filed: Oct. 18, 2002

(30) Foreign Application Priority Data
Oct. 19, 2001 (GB) 0125235.2

(51) Int. Cl. F16L 55/18

(52) U.S. Cl. 405/184.2; 138/98; 138/97

(57) ABSTRACT

A method of fitting a lining in a pipeline is disclosed comprising the steps of providing a flexible tubular liner having a cross section sized to fit the pipeline, attaching a pig which is a close fit in the pipeline to an end of the liner and locating the pig in the pipeline. The liner is compacted to a reduced cross-section on or prior to entry to the pipeline to facilitate passage of the liner along the pipeline, and a fluid pressure is applied to the pig to cause the pig to pass along the pipeline and, to draw the liner into the pipeline. The pig is removed from the pipeline and the liner restored to its original cross-section to engage around the inner periphery of the pipeline

For example, the liner may be of circular cross-section and is compacted by forming a re-entrant portion in the periphery of the cross-section to reduce the overall cross-section of the liner.

### BACKGROUND OF THE INVENTION

1. Field of the Invention

This invention relates to methods of fitting linings in subsea pipelines.

2. Background Prior Art

Pipelines are commonly used for transporting gases and liquids overland and on the seabed. In the case of offshore gas and oilwells, it is usual to provide a well-head on the seabed through which gas or oil from the well is extracted with a pressurised fluid which is usually water. The well-head is connected by a short length of pipeline to a seabed processing station where the water is extracted. The separated water is usually re-injected in the oil or gas reservoir and flows through small diameter pipelines from the separation/processing station to special water injection well-heads. Such pipelines are usually formed in steel and therefore prone to corrosion by the flow of water through the pipeline. Installing a plastic liner in the pipeline can prevent this.

There are a number of known methods for installing flexible plastic liners in pipelines. In one such method the liner in the pipe is pre-installed on-shore in a length of pipe which is wound onto a reel for transport.

European patent publication no. 0377486 discloses a method of lining a pipe in which a circular liner tube is reduced in cross section and is deformed into a non-circular shape. The reduced and deformed liner is then inserted into the pipe to be lined after which the liner is restored to its original circular shape within the pipe. For example the liner can be fed into the pipe by attaching a rope to one end and pulling it through the pipe. The liner is restored to its original cross section by pumping fluid under pressure into the liner in the pipeline to expand the liner into engagement with the pipeline.

These techniques are principally suitable for on shore pipeline lining and for lining relatively short lengths of not more than 1 kilometer. Longer pipelines could be made up from several short sections connected offshore.

### SUMMARY OF THE INVENTION

It is an object of the present invention to devise a method of lining a pipeline which can be used for seabed pipelines and for pipelines installed by installation techniques from a reel, for example J-lay or S-lay methods.

This invention provides a method of fitting a lining in a pipeline comprising the steps of providing a flexible tubular liner having a cross section sized to fit the pipeline, attaching a pig which is a close fit in the pipeline to an end of the liner, locating the pig in the pipeline, compacting the liner to a reduced cross-section on or prior to entry to the pipeline to facilitate passage of the liner along the pipeline, applying fluid pressure to the pig to cause the pig to pass along the pipeline and to draw the liner into the pipeline removing the pig from the pipeline and restoring the liner to its original cross-section to engage around the inner periphery of the pipeline.

The term “pig” as used throughout this specification is intended to mean an internal pipeline tool or probe as is standard in the pipelaying industry. In one application of the invention the liner may be of circular cross-section and may be compacted by forming a re-entrant portion in the periphery of the cross-section to reduce the overall cross-section of the liner.

In the case where the pipeline is laid on the seabed from above the surface and is initially empty, the pig may be inserted in an upper end of the pipeline at the surface and water may be delivered to the pipeline above the pig to create a head of water pressure on the pig which pushes the pig down the pipeline with the liner in tow. Water in the pipeline also minimises the friction between the liner and the pipe wall during pulling through of the pig.

In any of the above methods the cross-section of the compacted liner may be restored by a further pig or pigs having a cross-section sized to fit in the liner when erected in the pipeline, said pig or pigs being inserted in the liner at one end thereof and being delivered through the liner by fluid pressure to erect the liner after which the pig is removed from the liner.

Also in any of the above methods the pipeline may be a subsea pipeline laid on the seabed and the liner may be inserted in the pipeline during a laying operation of the pipeline on the seabed.

In the latter method a receiver for the pig may be attached to one end of a new length of pipeline to be laid on the seabed from the surface vessel, the pipeline is laid from the surface vessel until the required length of pipeline has been laid and the other end of the pipeline remains supported from the vessel, the pig is inserted into said other end of the pipeline with the liner attached thereto and is delivered through the pipeline to said one end of the pipeline into the probe receiver to draw the compacted liner along the pipeline, and a pipeline closure device is attached to said other end of the pipeline which is then lowered to the seabed.

More specifically said one end of the pipeline may be recovered from the seabed by the surface vessel, the pig receiver is removed with said one pig which is detached from the liner and another or series of pigs of increasing cross-section are then inserted in the liner and delivered by fluid pressure through the liner to expand the liner in to engagement around the pipeline, water in the pipeline being released from at the other end of the pipeline.

A longitudinal groove or grooves may be provided in the outer surface of the liner to facilitate escape of trapped water. The further pig may be received in a closure device at said other end of the pipeline after the pig has passed through the length of the pipeline.

### BRIEF DESCRIPTION OF THE DRAWINGS

The following is a description of some specific embodiments of the invention reference being made to the accompanying drawings in which:

FIG. 1 is a diagrammatic illustration of a subsea pipe laying operation using a pipe laying barge illustrating the initial laying of the pipeline;

FIG. 2 is a similar view to FIG. 1, showing the final stages of laying of the pipeline;

FIG. 3 illustrates the commencement of insertion of a plastics liner in the pipeline;

FIG. 4 is a detailed view of the pipeline and insertion of the liner in the pipeline in the region circled on FIG. 3;

FIG. 5 illustrates the completion of insertion of the liner in the pipeline and preparation of the final end of the pipeline prior to release to the seabed;

FIG. 6 illustrates the pipe laying barge in transit from the final end of the pipeline to be laid to the initial end of the pipeline laid;

FIG. 7 illustrates the recovery of the initial end of the pipeline laid from the seabed to the vessel;

FIG. 8 illustrates the preparation of the initially laid end of the pipeline on the barge for erection of the liner to encircle the inner wall of the subsea pipeline;

FIG. 9 is an enlarged view of a coupling encircled on FIG. 8;

FIG. 10 shows an initial stage in the erection of the liner;

FIG. 11 is a cross-sectional view through part of the subsea pipeline encircled on FIG. 9 showing a pig device travelling through the liner to erect the liner and three stages in the development of the cross-section of the liner in the pipeline; and

FIG. 12 shows the completion of the erection of the initially laid end of the pipeline to the seabed.

### DESCRIPTION OF THE PREFERRED EMBODIMENTS

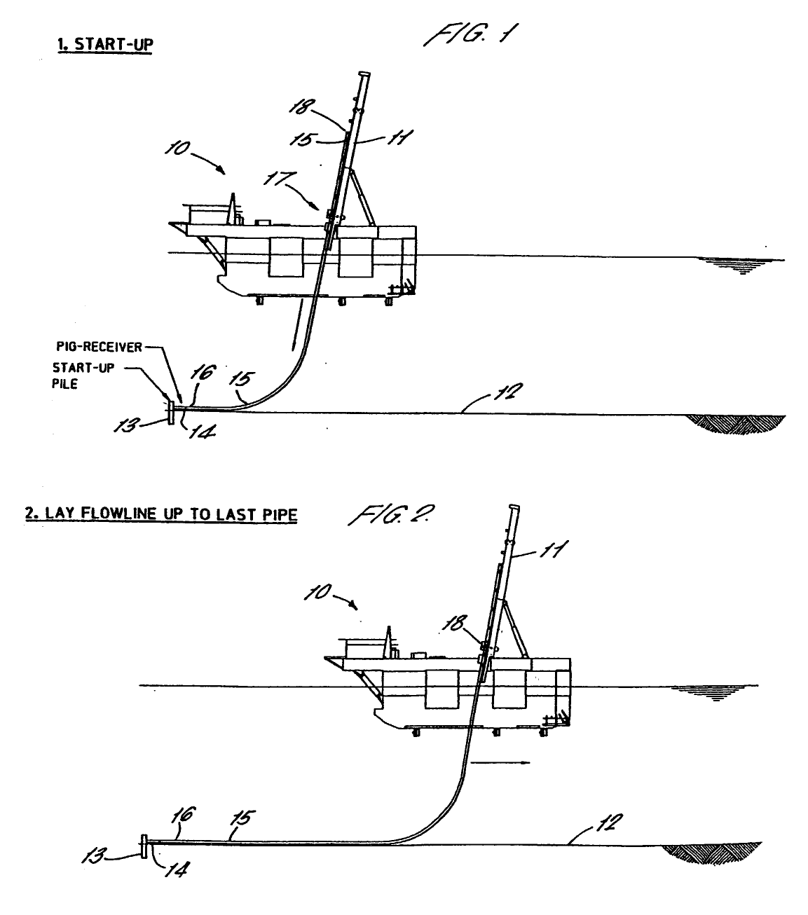

Referring firstly to FIG. 1 of the drawings, there is shown a pipe laying barge indicated generally at 10 equipped with an upright gantry structure inclined to the vertical indicated generally at 11 on which lengths of pipe are temporarily supported to be connected in a pipeline to be laid on the seabed indicated generally at 12. The system used by the barge is known as “J-lay” which is described in detail in U.S. Pat. Nos. 3,266,256 and 3,389,563. The name J-lay is derived from the fact that the pipeline extends in a generally J shape to the sea bed from the vessel as it is laid. The S-lay technique in pipe laying from a surface vessel is equally applicable.

In preparation for laying a length of pipeline a start up pile 13 is driven into the seabed as indicated to which a receiver 14 for a pipeline pig at an end of a length of pipeline is subsequently coupled. This is just one way of initiating pipelaying and other methods are equally applicable. Lengths of pipe 15 from which the subsea pipeline is to be formed are stored on the deck of the barge or on a adjacent barge. The receiver 14 is attached to an end 16 of a first length of pipeline 15 which is then lifted upright by a crane (not shown) onto the gantry structure 11 ready to be laid on the seabed, receiver end 16 first. The pipe is lowered on the gantry using a brake and guidance mechanism indicated at 17 at the lower end of the gantry, until the upper end 18 of the pipe is near the lower end of the gantry. The next pipe 15 is then located on the gantry and the lower end 16 is coupled to the upper end 18 of the previously placed pipe. The pipe assembly is then lowered by the gantry until the upper end 18 of the last laid pipe is adjacent the lower end of the gantry ready to receive the next length of pipe. The process is repeated until the pipe length reaches the seabed and assumes the J-shape as it lays on the sea bed as referred to above. The leading end 16 of the pipeline including the pig receiver is then coupled to the previously installed pile 13 by a cable (not shown). Further lengths of pipe are then added and the barge moved as necessary in the direction in which the pipeline is to be laid on the sea bed.

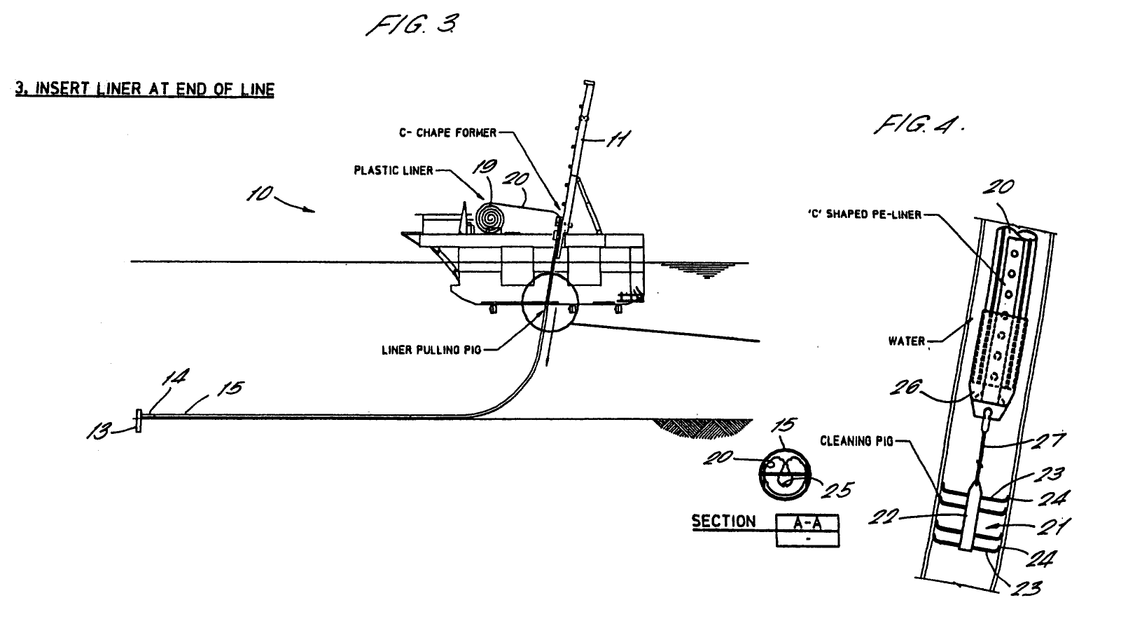

Pipe laying proceeds until the required length of pipeline has been laid on the seabed and the trailing end of the last length of pipe to be coupled in the pipeline is at the lower end of the gantry as shown in FIG. 2. At this stage the pipeline is empty and in particular is empty of water.

Such pipelines, maybe subject to internal corrosion particularly where pipeline is used to convey gas or oil from the well head to a processing station. Gas or oil is extracted using steam/water which then flows along the pipeline from the well head to the processing station where the water is removed. The separated water is usually re-injected in the oil or gas reservoir and flows through small diameter pipelines from the separated/processing station to special water injection well heads. The water present in the gas or oil with the pipeline causes corrosion in the pipeline and this invention is concerned with a method for preventing or minimizing corrosion. To that end a thermoplastic liner tube is located in the pipeline by the method which will now be described.

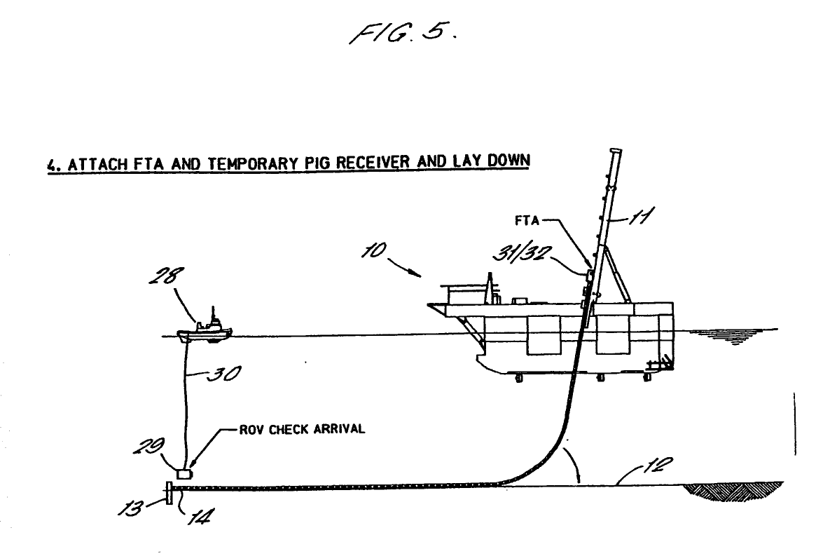

Referring now to FIGS. 3 and 4, a reel 19 of thermoplastic liner tube 20 is mounted on the vessel to be fed into the pipeline. As best seen in FIG. 4, a pig 21 is located in the open end of the last pipe 15 to be attached in the pipeline at the lower end of the tower. The pig comprises a central spine 22 on which two pairs of sealing discs 23 are mounted. The cleaning discs have annular flanges 24 at their outer peripheries the outer diameter of which is a close fit in the inner diameter of the pipe to form a seal with the pipe. To install the liner in the empty pipeline, the cross-section of the liner has to be decreased. This is achieved by folding the liner and applying straps to hold the liner compacted. More particularly liner 20 is pre-compacted by creating a re-entrant portion 25 in its cross-section to reduce the overall size of the liner cross-section for entry to the pipeline. A coupler 26 is bolted to the leading end or head of the liner and the coupler is connected by a wire strop 27 to the spine of the pig. In its compacted form the liner has a cross-section substantially less than that of the internal cross-section of the pipeline so that the liner can readily pass into the pipeline as can be best seen in FIG. 3. The liner is guided into the end of the pipe by a device not shown to feed the liner from the drum 18 to the pipe. The end of the pipe has a closure (not shown) through which the liner passes in sealing engagement.

Water is pumped into the pipeline above the pig until the resulting hydrostatic pressure acting vertically on the pig is sufficient to overcome the friction of the pig liner in the pipe. If the pig/liner stops after a while, further water is pumped in to the pipe connected to the pipe to drive the pig 21 down the pipe drawing the liner 20 with it from the reel 19.

Referring now to FIG. 5 of the drawings, a support vessel 28 is positioned over the location of the pig receiver 14 on the seabed and a ROV (Remote Operation Vehicle) comprising a subsea robot with cameras and manipulative arms is lowered over it. The arrival of the pig in the receiver is indicated by a pig signaller by moving a lever or changing the colour of a colour indicator and this is observed by a camera on the adjacent ROV. The supply of water to the pipeline is maintained until the ROV detects the arrival of the pig. The pig receiver prevents the pig from returning into the pipeline.

The liner is severed where it emerges from the end of the pipeline still supported on the gantry and is connected to the steel pipe by making a flange connection. An FTA (Flowline Termination Assembly i.e. a connector for subsea tie-in of the flowline to, for example, a well head structure)1 and a second temporary pig receiver 31, 32 are attached to the end of the pipeline on the gantry.

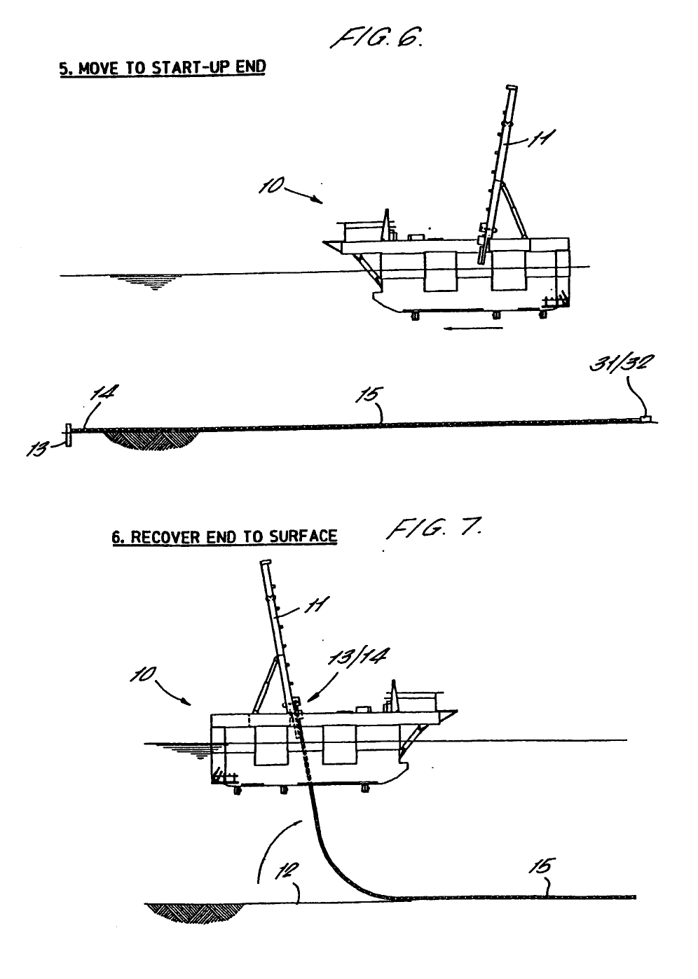

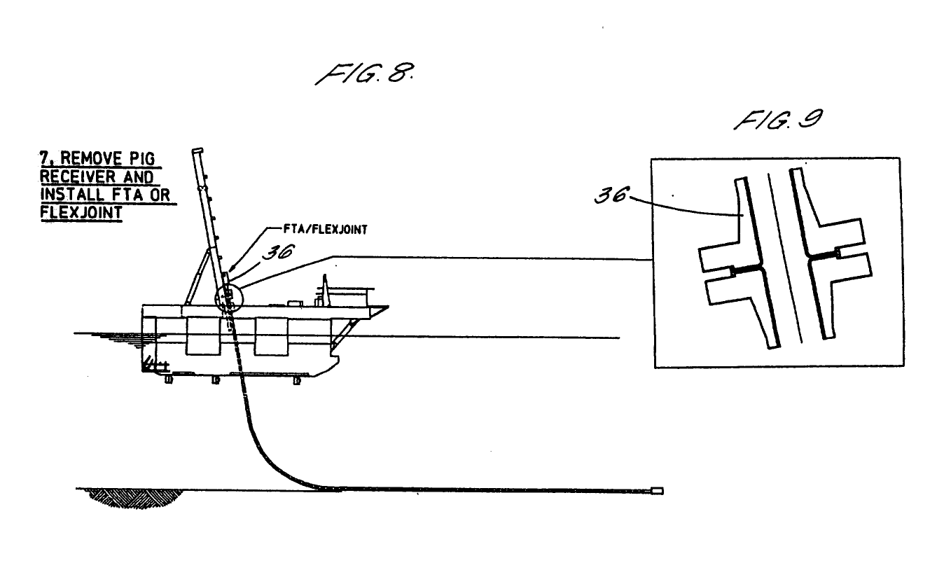

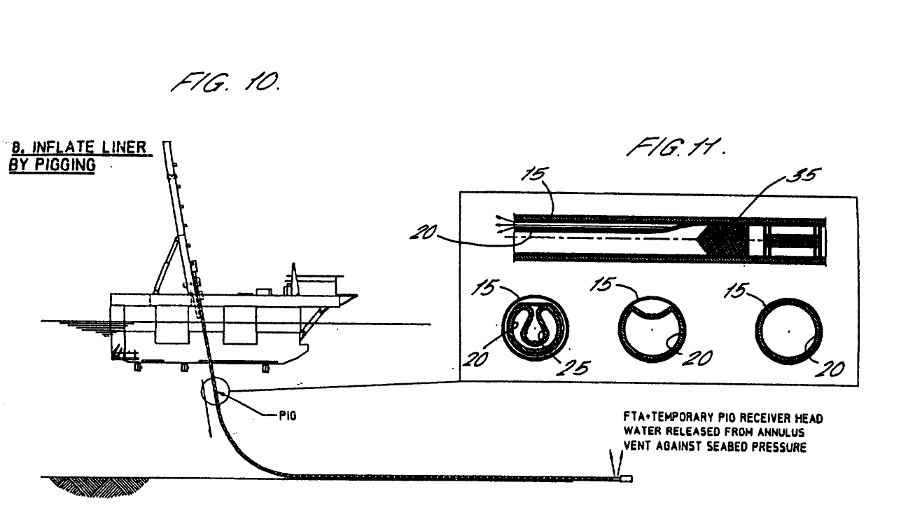

Laying of the remaining part of the pipeline with the ETA and pig receiver 31, 32 attached thereto from the barge is then completed forming a length of pipeline laid on the seabed as can be seen in FIG. 6. The barge then moves to the initial end of the pipeline laid on the seabed, the pig receiver 14 and pipeline are disconnected from the pile 13 and a winch on the barge is used to raise the end of the pipeline to the surface at the lower end of the tower as shown in FIG. 7. The pig receiver is then detached from the pipeline to recover the pig for future use. A flange connection is then made between the liner and pipe to anchor the end of the liner to the pipe.

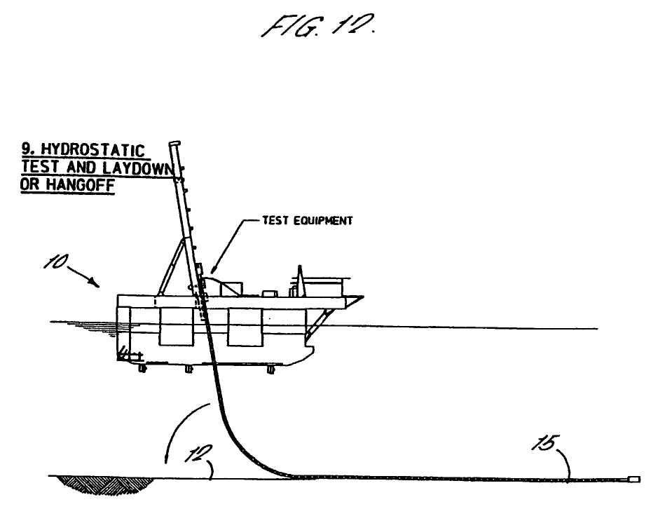

Now the still folded 35 liner is restored to its original shape by pushing a pig or a set of pigs of increasing cross-section through the liner as shown in FIG. 11. The original shape is thereby restored and the water between the liner and steel pipe is pushed towards the end of the pipeline by the expanding of the liner. In order to facilitate the water flow through the annulus, longitudinal grooves may be provided in the outer surface of the liner.

A supply of pressurized water (not shown) is coupled to the end of the pipeline to force the pig 35 through the liner and in so doing to expand the liner from the compacted C-shape form adopted for insertion in the pipeline to a fully annular form encircling the inner periphery of the pipeline. The water supply may be heated water to ease the expanding of the liner. The pressurized water supplied to the liner is maintained until the probe reaches the end of the liner and is received in the FTA-temporary pig receiver head attached to the other end of the pipeline. The temporary pig receiver has a valve controlled outlet for releasing water from the pipeline as the pig is forced along the pipeline.

A hydrostatic test can be carried on the liner to ensure that it is waterproof and the pipeline can then be laid down on the seabed or hung off the vessel.

The liner can be conveniently inserted in the pipeline by this method over extensive lengths of pipeline if required.

In an alternative method, a length of liner may be pre-installed in each pipeline section in which case the ends of the liner in adjacent lengths of pipe are welded together before the ends of the pipeline are brought together and connected by welding.

1. A method of fitting a lining in a pipeline comprising the steps of providing a flexible tubular liner having a cross section sized to fit the pipeline, attaching a pig which is a close fit in the pipeline to an end of the liner, locating the pig in the pipeline, compacting the liner to a reduced cross-section on or prior to entry to the pipeline to facilitate passage of the liner along the pipeline, applying fluid pressure to the pig to cause the pig to pass along the pipeline and, to draw the liner into the pipeline, removing the pig from the pipeline and restoring the liner to its original cross-section to engage around the inner periphery of the pipeline.

2. A method as claimed in claim 1, wherein the liner is of circular cross-section and is compacted by forming a re-entrant portion in the periphery of the cross-section to reduce the overall cross-section of the liner.

3. A method as claimed in claim 1, wherein the pipeline is a subsea pipeline laid on the seabed and the liner is inserted in the pipeline during a laying operation of the pipeline on the seabed.

4. A method as claimed in claim 3, and in the case where the pipeline is laid on the seabed from a location above the surface and is initially empty, wherein the pig is inserted in the end of the pipeline at the surface and water is delivered to the pipeline above the pig to provide a head of water pressure on the pig which pushes the pig down the pipeline with the liner in tow.

5. A method as claimed in claim 3 wherein a receiver for the pig is attached to one end of a new length of pipeline to be laid on the seabed from the surface vessel, the pipeline is laid from the surface vessel until the required length of pipeline has been laid and the other end of the pipeline remains supported from the vessel, the pig is inserted into said other end of the pipeline with the liner attached thereto and is delivered through the pipeline to said one end of the pipeline into the pig receiver to draw the compacted liner along the pipeline, and a pipeline closure device is attached to said other end of the pipeline which is then lowered to the seabed.

6. A method as claimed in claim 5, wherein said one end of the pipeline is recovered from the seabed by the surface vessel, the pig receiver is removed with the pig which is detached from the liner, a second pig is then inserted in the liner and delivered by fluid pressure through the liner to erect the liner in the pipeline, water in the pipeline being released from the other end of the pipeline.

7. A method as claimed in claim 6, wherein the pig is sized to expand the compacted liner to engage around the pipeline in one pass along the pipeline.

8. A method as claimed in claim 6, wherein a series of pigs of increasing cross-section is used to expand the liner in stages to engage around the pipeline.

9. A method as claimed in claim 8, wherein the further pig or pigs are received in the closure device at said other end of the pipeline after the pig or pigs have passed through the length of the pipeline.

10. A method as claimed in claim 4, wherein a receiver for the pig is attached to one end of a new length of a pipeline to be laid on the seabed from the surface vessel, the pipeline is laid from the surface vessel until the required length of pipeline has been laid and the other end of the pipeline remains supported from the vessel, the pig is inserted into said other end of the pipeline with the liner attached thereto and is delivered through the pipeline to said one end of the pipeline into the pig receiver to draw the compacted liner along the pipeline, and a pipeline closure device is attached to said other end of the pipeline which is then lowered to the seabed.
